(19) United States
(12) Patent Application Publication
(10) Pub. No.: US 2004/0156389 A1
(43) Pub. Date: Aug. 12, 2004

(54) Cross-layer communication solution(s) across different communication protocols

(75) Inventor: Yung-Ching Sha, Edison, NJ (US)

Correspondence Address: MOSER, PATTERSON & SHERIDAN L.L.P., 595 SHREWSBURY AVE, STE 100, FIRST FLOOR, SHREWSBURY, NJ, 07702, US

(73) Assignee: LUCENT TECHNOLOGIES INC.

(21) Appl. No.: 10/364,149

(22) Filed: Feb. 11, 2003

(51) Int. Cl. H04J 3/22

(52) U.S. Cl. 370/466

(57) ABSTRACT

A method, system and apparatus for receiving, from a first communication channel utilizing a first protocol, a data structure adapted to the first protocol including condition indicative data, copying the condition indicative data to a non-transient position of a data structure adapted to a second protocol, and transmitting the second data structure via a second communication channel utilizing the second protocol.

### FIELD OF INVENTION

The invention relates generally to the field of communication systems and, more specifically, to communication across different communication protocols.

### BACKGROUND OF INVENTION

Interface (IF) communication cards typically contain a line side and a client side. Each respective side is configured to accept and transmit information under a specific protocol. Information usually comprises two parts: a header and a payload. Usually an IF card receives information sent using a first protocol and forwards the information using a second protocol. However, when the IF card forwards the information from a channel using a first protocol to a channel using a second protocol, the information within the header associated with each respective protocol is not forwarded with the payload to the next protocol. Thus, information pertaining to the first channel protocol (e.g., signal degradation (“SD”) or signal failure (“SF”) flags) within the header is dropped by the IF after reception, and information pertaining to the second channel protocol is attached to the payload.

For example, DWDM interface cards may process only SONET layer signals on the client side and process only DWDM layer signals on the line side (e.g., Digital Wrapper or G.709). As a result, there is no cross-layer communication between the line and client communication sides of header information.

### SUMMARY OF THE INVENTION

The invention comprises a method, system and apparatus for receiving, from a first communication channel utilizing a first protocol, a data structure adapted to the first protocol including condition indicative data, copying the condition indicative data to a non-transient position of a data structure adapted to a second protocol, and transmitting the second data structure via a second communication channel utilizing the second protocol.

### BRIEF DESCRIPTION OF THE DRAWINGS

The teachings of the present invention can be readily understood by considering the following detailed description in conjunction with the accompanying drawings, in which:

FIG. 1 depicts a block diagram of a communications system according to an embodiment of the invention;

FIG. 2 depicts a high-level block diagram of a controller suitable for use in the communications system of FIG. 1;

FIGS. 3A-3D depict embodiments of data structures suitable for use with the invention;

FIG. 4 depicts a flow diagram of a method used in accordance with the invention; and

FIGS. 5A-5C depict various examples useful in understanding the present invention.

To facilitate understanding, identical reference numerals have been used, where possible, to designate identical elements that are common to the figures.

### DETAILED DESCRIPTION OF THE INVENTION

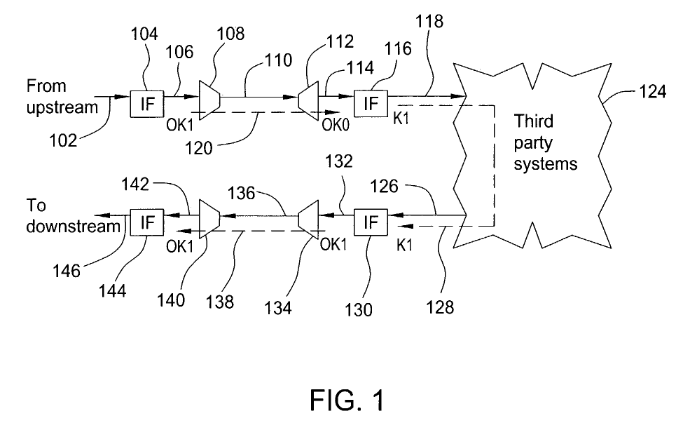

FIG. 1 depicts a block diagram of a communications system according to an embodiment of the invention. Specifically, the system receives information from an upstream source (not shown) via a path 102, and transmits information towards a downstream source (not shown) via a path 106.

The information generally includes a plurality of packets including payload and header portions. The payload includes data being transmitted (e.g., voice, video and the like), and the header portion includes control information, status flags and the like in accordance with the underlying transmission protocol. The header information provides data necessary for the transmission of the payload information along a channel using a respective protocol (in this example, the SONET and DWDM protocols). The header typically comprises a plurality of overhead bytes. Some of the overhead bytes are used while others remain unused.

An interface 104 receives information via path 102 and adapts the received information according to requirements of a first protocol. For simplicity and illustrative purposes only, the first protocol is described hereinafter as the DWDM protocol (though other protocols may be used). For illustrative purposes only the OK1 (a digital wrapper or G.709 overhead byte) overhead byte to describe the invention herein. However, this illustration is not intended to limit the scope of the invention in any way. For example, other overhead bytes (depending on the protocol) such as F, Z, and RES bytes may also be processed in the manner described herein with respect to the OK1 byte.

The DWDM adapted information from the IF 104 (and information from other IF cards and/or other information stream sources (not shown)0 are transported along respective paths 106 (and other paths) towards a multiplexer 108 for multiplexing. The multiplexer 108 produces a multiplexed information stream according to the first protocol, which information stream is transported to a demultiplexer 112 via a communications link 110 using said first protocol. At least the desired information stream is demultiplexed by the demultiplexer 112 and provided to an interface 116 via path 114.

The interface 116 receives the desired information stream and adapts the desired information stream according to the requirements of a second protocol. That is, the data structure of the information stream received by IF 116 is adapted to the data structure appropriate to the second protocol.

For simplicity and illustrative purposes only, the second protocol is described hereinafter as the Synchronous Optical Network (“SONET”) protocol (though other protocols can be used). In addition, the K1 overhead byte is used throughout for illustrative purposes only. However, these illustrations are not intended to limit the scope of the invention in any way. For example, other overhead bytes and other protocols may be used in accordance with the invention, such as SDH. The copying of the header information (from the OK1 overhead byte) under the DWDM protocol into a non-transient portion (the K1 overhead byte) of the data structure under the SONET protocol is transparent to the SONET protocol, i.e., the copied DWDM header information is not lost or modified by SONET. In addition, the data structure now includes the SONET overhead bytes, the DWDM overhead bytes (OK1 copied to the K1 byte), and the payload.

Interface 116 copies the information from at least the OK1 DWDM header byte of the received data structure to at least the K1 SONET overhead byte of a transmitted or provided data structure. The resulting information is transmitted along path 118 towards third party systems 124. The transmission of the information originally stored within the OK1 byte (now stored within the K1), towards the third party systems 124, is depicted by along path 122. The third party systems 124 (e.g. a SONET ring) transmit the information, including the original OK1 overhead information within header byte K1, along path 126 towards interface 130. The transmission, by the third party systems 124, of the information originally stored within the OK1 byte (now stored within the K1), towards IF 130, is depicted by along path 122

Interface 130 receives information from the third party systems 124 and adapts the received information according to the requirements of a third protocol, illustratively the same protocol as the first protocol. The interface 130 copies the overhead byte information within the SONET K1 overhead byte of the received data structure to the DWDM OK1 overhead byte of the structure to be transmitted (i.e., the interface 130 output). The interface 130 transmits the desired information stream to a multiplexer 134 via path 132.

The multiplexer 134 produces a multiplexed information stream according to the first protocol, which information stream is transported to a demultiplexer 140 via a communications link 136 using said first protocol. At least the desired information stream is demultiplexed by the demultiplexer 140 and provided to an interface 144 via path 142. The transmission of the OK1 byte from the IF 130 towards the IF 144 is depicted via path 138.

The interface 144 receives the desired information stream and adapts the desired information stream according to the requirements of an end user (or a second protocol). That is, the data structure of the information stream received by IF 144 is adapted to the data structure appropriate for use by an enduser.

While FIG. 1 depicts the downstream transmission of information, it will be appreciated that the invention may also be used for upstream transmission.

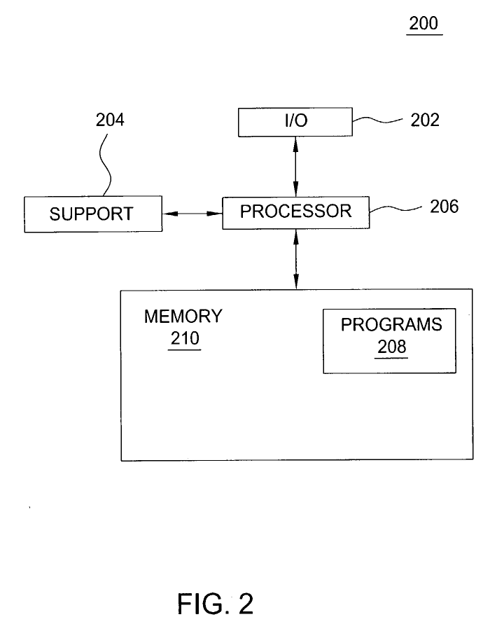

FIG. 2 depicts a high-level block diagram of a network manager or controller suitable for use in the communications system of FIG. 1.

Specifically, the controller 200 may be used to implement, or be included within, the various functional elements described herein, such as interfaces, multiplexers, demultiplexers, managers and the like. The exemplary controller 200 of FIG. 2 comprises a processor 206 as well as memory 210 for storing various control programs 208 and condition indicative method 300. The processor 206 cooperates with conventional support circuitry 204 such as power supplies, clock circuits, cache memory and the like as well as circuits that assist in executing the software routines stored in the memory 210. As such, it is contemplated that some of the process steps discussed herein as software processes may be implemented within hardware, for example, as circuitry that cooperates with the processor 206 to perform various steps. The controller 200 also contains input/output (I/O) circuitry 202 that forms an interface between the various functional elements communicating with the controller 200.

Although the controller 200 of FIG. 2 is depicted as a general purpose computer that is programmed to perform at various control functions in accordance with the present invention, the invention can be implemented in hardware as, for example, an application specific integrated circuit (ASIC). As such, the process step described herein is intended to be broadly interpreted as being equivalently performed by software, hardware or a combination thereof.

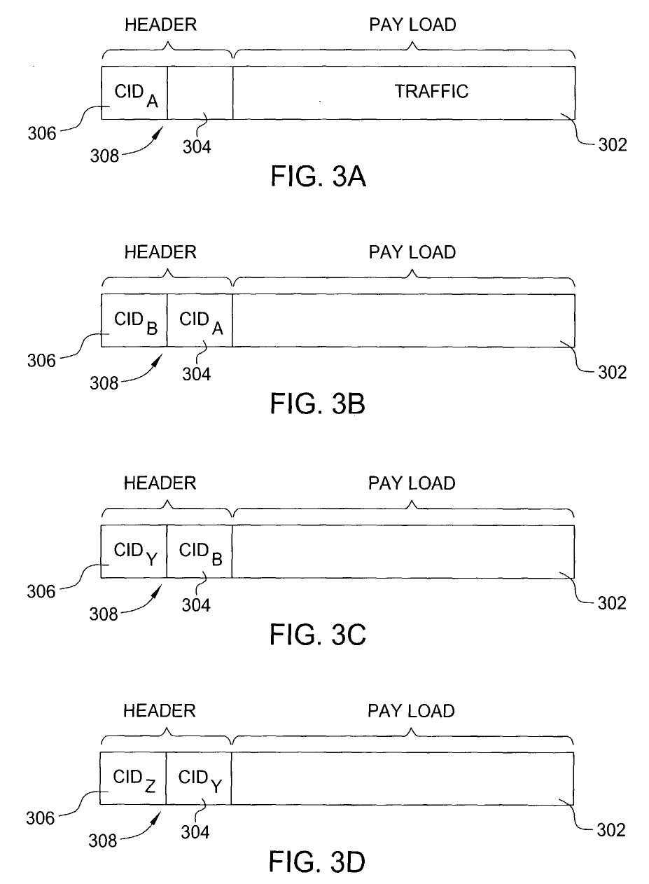

FIGS. 3A-3D depict embodiments of data structures suitable for use in accordance with the invention. Specifically, FIG. 3A depicts an exemplary data structure 300A suitable for use in transporting information between interfaces 104 and 116. Data structure 300A contains a header 308 and a payload 302. Condition indicative data (CID) and other data is stored within the header 308, though not all of the overhead bytes within the header 308 are used by a protocol. That is, although part of the header transmission contains information, some of the header bytes typically contain no information. Thus, header 308 comprises overhead bytes 306 used by the current protocol and overhead bytes 304 containing no information used by the current protocol. Because the current protocol does not place information in the unused bytes, the unused bytes are transparent to devices and processed using the current protocol. The method, system, and apparatus, respectfully, take advantage of the unused bytes.

FIG. 3B depicts an exemplary data structure 300B suitable for use in transporting information between interface 116 and third party systems 124. Specifically, the interface 116 receives the condition indicative data 306 stored in header 306 and payload 302, from interface 104. Interface 116 copies the condition indicative data, e.g., signal failure information, stored in header 306 into unused header(s) 304, adds condition indicative data for the current protocol into header byte(s) 306, and forwards the payload 302 with information stored within headers 304 and 306 to third party systems 124.

FIG. 3C depicts an exemplary data structure 300C suitable for use in transporting information between the third party systems 124 and interface 130. Specifically, interface 130 receives the information stored in payload 302, SONET header byte 306 and information copied to the unused header bytes 304. For example, third party systems 124 transmit the payload 302, SONET header byte 306, and DWDM condition indicative data copied to the K1 unused header byte 304. Interface 130 copies the information from the K1 byte to the OK1 unused byte of the DWDM protocol. Interface 130 transmits, using the DWDM protocol, the payload 302, the DWDM condition indicative data stored in 306, and the copied K1 condition indicative data stored to the OK1 unused byte 304.

FIG. 3D depicts an exemplary data structure 300D suitable for use in transporting information between interface 130 and interface 144. Specifically, interface 144 receives the information stored in payload 302, the DWDM condition indicative data stored in header byte 306, and the SONET condition indicative data copied from the K1 byte to an unused DWDM header byte 304. Interface 144 forwards the payload 302 downstream to an end-user.

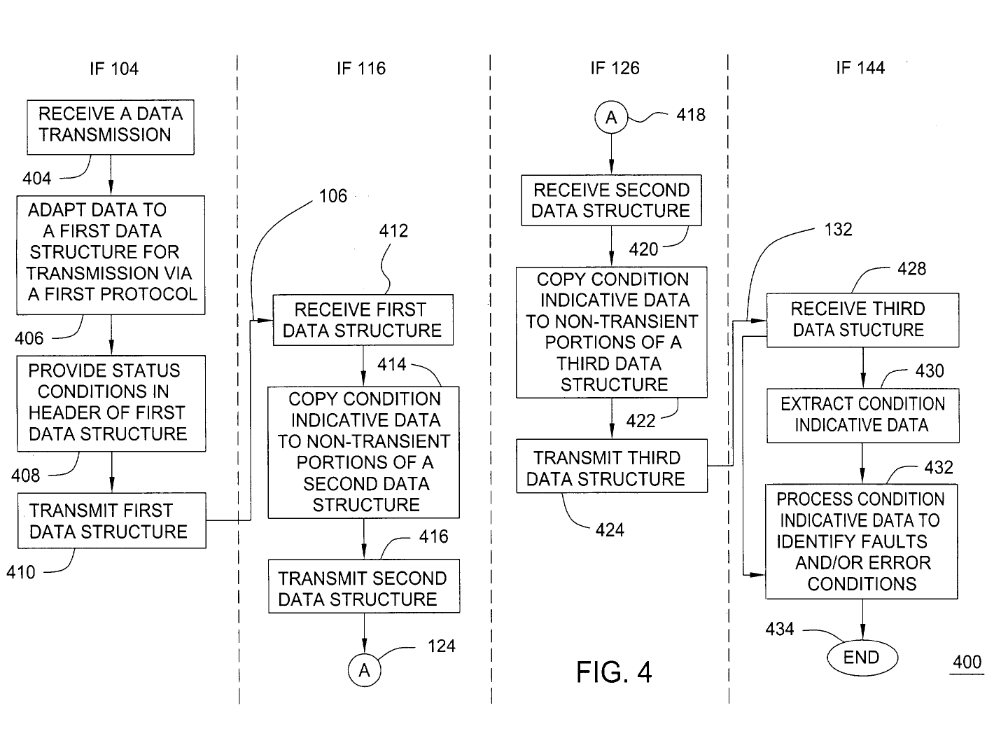

FIG. 4 depicts a flow diagram of a method in accordance with the invention. Specifically, the method 400 begins at step 404 when IF 104 receives data for transmission.

At step 406, IF 104 adapts the data to a first data structure for transmission along a channel via a first protocol (e.g., the DWDM protocol). Specifically, the IF 104 places the payload in the first data structure.

At step 408, status conditions, indicative of the first protocol (illustratively the DWDM protocol), are placed in the header of the first data structure. For illustrative purposes only, condition indicative data is place in the OK1 byte. The condition indicative data may include, for example information indicative of signal failure and/or signal degradation.

The IF 104 subsequently transmits, at step 410, the first data structure, along path 106, towards IF 116. IF 116 receives, at step 412, the information bearing first data structure.

At step 414, IF 116 copies the condition indicative data (stored in the header bytes of the first data structure) to non-transient portions of a second data structure. The second data structure is adapted for transmission, along a channel, via a second protocol (e.g., the SONET protocol). The non-transient portions of the second data structure are defined herein as bytes that are not used by a protocol. Typically, this header information transported along a channel using one protocol is dropped when the payload is transported along a different channel using another protocol.

So that the condition indicative data within the header is not dropped, the interface, at step 414, copies the condition indicative data (e.g., signal failure and/or signal degradation stored in the OK1 byte) to an unused header byte of a second data structure (e.g., to the K1 byte of the SONET protocol). The inventive method also places data associated with the SONET protocol in the header bytes normally used by the SONET protocol.

At step 416, IF 116 transmits the second data structure (containing the payload, condition indicative data of the first data structure in a non-transient header portion of the second protocol, and the condition indicative data associated with the second protocol) towards third party systems 124 (or other transmission channels for transmission using other protocols). Third party systems 124 may further modify the data structure, for transmission by and within the third party systems 124. However, such modification does not prevent the transmission downstream/upstream of the payload or condition indicative data. Although FIG. 4 depicts the IF 116 transmitting the second data structure towards third party systems 124 that depiction is for illustrative purposes only. It is appreciated that IF 116 may, in other embodiments, transmit the second data structure downstream/upstream towards other IF's.

The third party systems 124 transmits the second data structure, at step 418, towards IF 130. At step 420, IF 130 receives the second data structure.

The IF 130, at step 422, copies the condition indicative data to a non-transient portions of a third data structure. Specifically, IF 130 receives the second data structure and copies the information from the K1 byte (originally stored in the OK1 byte) to an unused byte of a data structure adapted to a third protocol.

At step 424, IF 130 transmits the third data structure, via a third protocol, along path 132, towards IF 144. The third protocol and data structure may be the same as or different from the first protocol/data structure. For example, the third protocol may be DWDM or SDH and has a third data structure correspondingly adapted for transmission using either respective protocol.

At step 428, IF 144 receives and transmits the third data structure. The method 400 ends at step 434.

Method 400 optionally includes steps 430 and 432. Method 400 may, at step 430, extract the condition indicative data, from the header, and, at step 432, interpret the information copied into unused portions of the header. The method ends at step 434.

The method 400 may also optionally include multiplexing and demultiplexing of the data structure (including copied condition indicative data) for transmission downstream/upstream.

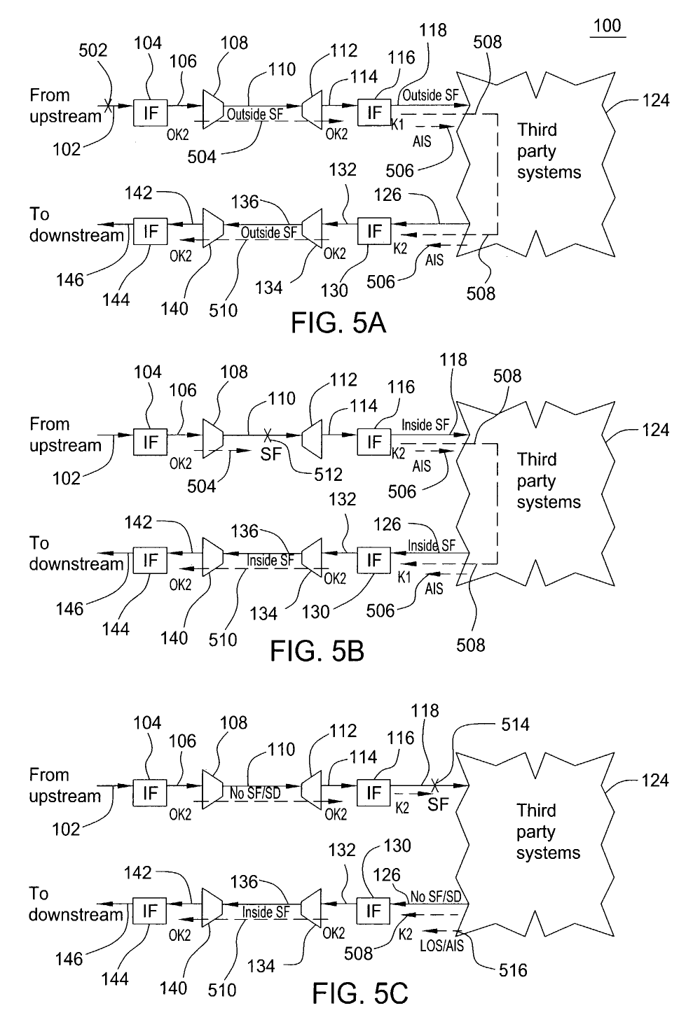

FIGS. 5A-5C depict various examples useful in understanding the invention. Particularly, the invention allows detection of where signal failures or signal degradation occurs in a communication channel. In FIGS. 5A-5C elements have been numbered similarly to the elements as described in FIG. 1. For brevity, the functions performed by the similarly numbered elements will not be repeated.

Generally, four conditions that will result in SF or SD at the interface 144; namely, a SF/SD condition outside the monitoring path; SF condition in the monitoring path; a SD condition in the monitoring path; no SF/SD condition (default bit pattern). These conditions are carried by two bits in the SONET K2 byte and the DWDM (Digital Wrapper or G.709) OK2 byte, respectively. However, other overhead bytes such as F, Z, and RES bytes may be alternative used.

In FIGS. 5A-5C, SD's or SF's that occur between IF 104 and IF 144 are considered “inside SD/SF.” Referring to FIG. 5A, break 502 indicates that a problem has occurred, e.g., a signal failure, in transmission channel 102 prior to interface 104. IF 104 detects a SF upstream, IF 104 sends a signal 504 downstream an ‘OK2=Outside SF’ signal to the IF 116. The IF 116 copies the OK2 overhead byte information into the K2 SONET overhead byte and sends a SONET (“AIS”) 506 downstream. The IF 130 receives ‘K2=Outside SF’ 508 and the SONET AIS 506. The IF 130 copies K2 into OK2. Finally, the IF 144 receives ‘OK2=Outside SF’ and reports it to fault management.

Referring to FIG. 5B, a SF between IF's 104 and 116 (an inbound failure). The IF 116 sends ‘K2=Inside SF’ and SONET AIS downstream. The IF 130 receives ‘K2=Inside SF’ and SONET AIS. The IF 130 copies K2 into OK2. Finally, the IF 144 receives ‘OK2=Inside SF’ and reports it to fault management.

Referring to FIG. 5C, a SF between IF 116 and the third party systems 124. The IF 130 either detects a loss of signal (“LOS”) or receives ‘K2=No SF/SD’ and SONET AIS. The IF 130 sends ‘OK2=Inside SF’ to the IF 144. Finally, the IF 144 receives ‘OK2=Inside SF’ and reports it to fault management.

Although FIGS. 5A-5C have been described with respect to SF one skilled in the art will appreciate that the above invention may also be used to determine SD.

Although various embodiments that incorporate the teachings of the present invention have been shown and described in detail herein, those skilled in the art can readily devise many other varied embodiments that still incorporate these teachings.

What is claimed is,

1. A method comprising:
receiving, from a first communication channel utilizing a first protocol, a data structure adapted to said first protocol including condition indicative data;
copying said condition indicative data to a non-transient position of a data structure adapted to a second protocol; and
transmitting said second data structure via a second communication channel utilizing said second protocol.

2. The method of claim 1, wherein one of said first protocol or said second protocol is DWDM.

3. The method of claim 2, wherein a remaining one of said first protocol or said second protocol is SDH.

4. The method of claim 1, wherein a remaining one of said first protocol or said second protocol is SONET.

5. The method of claim 4, wherein said condition indicative data is copied from OK1 byte to a K1 byte.

6. The method of claim 4, wherein said condition indicative data is copied from a K1 byte to a OK1 byte.

7. A system comprising:
at least one device for receiving, from a first communication channel, a data structure adapted to a first protocol including condition indicative data, copying said condition indicative data to a non-transient position of a data structure adapted to a second protocol, and transmitting said second data structure via a second communication channel utilizing said second protocol.

8. The system of claim 7, wherein said non-transient position is located within a header of said second data structure.

9. The system of claim 7, wherein one of said first protocol or said second protocol is DWDM.

10. The system of claim 9, wherein a remaining one of said first protocol or said second protocol is SONET.

11. The system of claim 9, wherein a remaining one of said first protocol or said second protocol is SDH.

12. The system of claim 7, wherein said condition indicative data is indicative of a signal failure or a signal degradation.

13. The system of claim 7, wherein said at least one device is an interface card.

14. An apparatus comprising:
means for receiving a data structure, from a first communication channel, adapted to a first protocol including condition indicative data;
means for copying said condition indicative data to a non-transient position of a data structure adapted to a second protocol; and
means for transmitting said second data structure via second communication channel utilizing said second protocol.

15. The apparatus according to claim 14, wherein each of said means are performed by an interface card.

16. The apparatus according to claim 14, wherein said non-transient position is located within a payload of said second data structure.

17. The apparatus according to claim 14, wherein said non-transient position is located within a header of said second data structure.

18. The apparatus according to claim 14, wherein one of said first protocol or said second protocol is SONET.

19. The apparatus according to claim 14, wherein a remaining one of said first protocol or said second protocol is DWDM.

20. The apparatus according to claim 14, wherein said condition indicative data is stored in at least one byte.
